(19) United States
(12) Patent Application Publication
(10) Pub. No.: US 2026/0286640 A1
(43) Pub. Date: Sep. 24, 2026

(54) ANCHORING MEMBER FOR A FACING PANEL FOR STABILISED EARTH STRUCTURES

(71) Applicant: OFFICINE MACCAFERRI S.P.A., Milano (MI) (IT)

(72) Inventors: Ratnakar Ramesh MAHAJAN, Kharedi, Pune (IN); Giulia LUGLI, Carpi (MO) (IT)

(21) Appl. No.: 19/472,133

(22) PCT Filed: Mar. 26, 2024
(86) PCT No.: PCT/IB2024/052877

§ 371 Date: Oct. 3, 2025

(30) Foreign Application Priority Data
Apr. 6, 2023 (IN) 202311026058

(51) Int. Cl. E02D 29/02; B28B 7/16

(52) U.S. Cl. CPC E02D 29/0233; B28B 7/16; E02D 29/0266; E02D 2250/0007; E02D 2250/0023; E02D 2300/002; E02D 2600/30

(57) ABSTRACT

An anchoring member for incorporation in a facing panel for constructing stabilised earth structures. The anchoring member includes a shell defining a recess with an opening. The anchoring member further includes an anchoring bar extending transversely inside the recess and around which anchoring bar an elongate reinforcement element is passed, during use. The shell is formed by at least one base portion carrying the anchoring bar and by a front portion defining the opening. The front portion of the shell is able to be selectively disassembled for recycling or reuse in manufacturing other facing panels.

### FIELD OF THE INVENTION

The present invention relates to panels which are used in the façade of stabilised earth structures. The invention is particularly directed towards an anchoring member, in the sector also referred to as a “connection member”, for connecting a façade panel to an anchoring element or reinforcement element in a stabilised earth structure. The invention is further directed towards a façade panel which comprises at least one of these anchoring members and the method for manufacturing such a façade panel.

### TECHNOLOGICAL BACKGROUND

A stabilised earth structure is a structure which is used to construct containment walls, embankments, bridge abutments or the like. In the stabilised earth structure, it is known to encase reinforcement elements in an earth substrate so as to obtain an earth structure which is generally stable as a result of the friction which is developed between the filling earth and the reinforcement elements. In some known solutions, the reinforcement elements are in the form of long webs. The stabilised earth structure is delimited by façade panels which are normally prefabricated and which are positioned beside each other and provided on the rear with anchoring members, to which there are fixed the webs which constitute the reinforcement elements of the stabilised earth.

There are known anchoring members which are constructed by means of shaped metal rods which are partially embedded in the concrete with which the façade panels are constructed. These metal rods are bent so as to form a ring or an eyelet which projects from the rear wall of the façade panel and in which the reinforcement element is introduced. In some cases, there have been constructed anchoring members which comprise pairs of rings which project from the rear face of the façade panel and in which there is inserted a cylinder, around which in turn the reinforcement element is passed. This construction is very laborious and requires a discrete manual implementation for the correct construction of the anchoring members. Furthermore, the fact that the anchoring members project from the rear wall of the façade panels makes them subject to impacts and makes the stacking of the front panels one on the other for transport not very practical. These projecting anchoring members which are constructed by means of metal rods are further subject to oxidation.

U.S. Pat. No. 5,839,855 sets out a method for constructing C-shaped cavities, in which to insert the reinforcement elements, in the rear wall of the façade panel. Of these façade panels, it may be appreciated that there are no anchoring members which project at the rear. However, the construction of the C-shaped cavities according to what is described and illustrated in U.S. Pat. No. 5,839,855 is particularly complex and expensive both in terms of time and as a result of the need for qualified operators who know how to position and remove from the concrete the cores which are used to construct the undercut C-shaped cavities.

WO 2016/142739 from the same Applicant describes an anchoring member for a façade panel to be used in constructing stabilised earth structures. Such an anchoring member provides for a shell defining a recess with a mouth, wherein a tubular anchoring bar which extends transversely in the recess and in which one of the reinforcement bars of the façade panel which is made from concrete can be inserted. The anchoring member is particularly convenient and effective. However, because this anchoring member is made from plastics material, the Applicant has set itself the objective of reducing the quantity thereof which remains incorporated in the façade panel inside the stabilised earth structure.

An object of the present invention is therefore to improve the known anchoring members in order to reduce the cost and the environmental impact thereof without thereby reducing the characteristics of resistance and convenience of use thereof.

### STATEMENT OF INVENTION

An object of the invention is therefore to improve the existing anchoring members, by reducing the disposable material which remains incorporated in the façade panels once the stabilised earth structures have been completed. Another object of the invention is to provide an anchoring member which is convenient and simple to use, economical and reliable.

Another object is to provide a façade panel for constructing stabilised earth structures which is at the same time strong, easy to construct and economical.

These objects and other objects are achieved by the invention which is defined in the appended claims and which is directed towards an anchoring member, a façade panel incorporating one or more of these anchoring members and a method for manufacturing such a façade panel.

According to a first aspect, there is described an anchoring member which can be incorporated in a façade panel for constructing stabilised earth structures. The anchoring member comprises a shell which defines a cavity, or recess, with an opening, or mouth. Furthermore, the anchoring member comprises an anchoring bar, preferably tubular, which extends transversely inside the recess. An elongate reinforcement element can be passed, during use, around this anchoring bar. The shell can be formed by at least a base portion, which carries the anchoring bar, and a front portion, which defines the opening and can be releasably attached to the base portion. In this way, the front portion can be selectively disassembled from the base portion and possibly extracted from the façade panel once it has been manufactured, to be recycled or re-used, for example to form, together with another base portion, a new anchoring member.

According to a particular aspect, it is described how the base portion of the shell can be engaged with the front portion, for example by means of engaging members, in a disengageable manner. These engaging members can comprise one or more flexible tongues which can be selectively engaged or disengaged from respective teeth. Preferably, the flexible tongues are formed in one piece on the base portion which remains incorporated in the façade panels after the manufacture thereof. On the other side, the teeth are preferably formed in one piece on the front portion. According to a particular aspect, the flexible tongues may have projections which can be raised by hand by an operator in such a manner that it is convenient and rapid to disengage the tooth from the base portions in order to recycle or re-use the front portion. Naturally, it is also possible to provide the opposite configuration, wherein the flexible tongues are formed in one piece on the front portion whereas the teeth are formed in one piece on the base portion. In some cases, there can be provided intermediate solutions, in which some teeth are formed in one piece on the front portion while other teeth are formed in one piece on the base portion, and vice versa, for the flexible tongues which can be connected to these teeth, respectively.

According to another aspect, it is described how the anchoring member can be constructed entirely by moulding a plastics material. Another aspect which is described is the fact that the anchoring bar may be tubular in order to allow during use the insertion therein of a mesh reinforcement bar element or, as an alternative to the mesh reinforcement bar element, a bar section, which is separated from the mesh reinforcement, but which is preferably operationally connected and interacts therewith. It is also described how the anchoring bar can be constructed in one piece with the base portion of the shell. Alternatively, the anchoring bar can be constructed as a separate piece from the base portion of the shell, for example, by means of a tubular element which is inserted in two opposite holes in the base portion of the anchoring member.

According to another aspect, it is described how the anchoring bar may be tubular with an internal diameter greater than the diameter of a mesh reinforcement bar or a bar section which is inserted therein. In this way, the concrete can enter inside the anchoring bar to strengthen it while it surrounds the mesh reinforcement bar or the bar section. The internal diameter of the tubular anchoring bar can preferably vary from being just slightly larger than the diameter of the bar which is introduced therein, to preferably approximately double than the diameter of the bar.

According to another aspect, it is described that centring members can be optionally mounted at the ends of the anchoring bar, preferably disposed outside the recess or cavity of the shell, at both sides thereof, in order to keep centred the mesh reinforcement bar or the bar section inside the anchoring bar.

According to another aspect, there is described a façade panel for a stabilised earth structure. The façade panel comprises a front exposed face and a rear face. The rear face is positioned, during use, in contact with a mass of earth. At least one cavity, or recess, with an opening, or mouth, is formed on the rear face of the façade panel. An anchoring bar extends transversely inside the recess. During use, an elongate reinforcement element, which is to this end inserted in the opening, can be made to pass around the anchoring bar to stabilise the earth structure. The recess is defined by the shell of an anchoring member which may have the above-mentioned features. The anchoring member can be incorporated inside the façade panel in such a manner that the opening thereof is substantially aligned with the rear face of the façade panel.

Preferably, there is encased in the façade panel a mesh reinforcement which is formed by bars which form a grid. The anchoring bar can be tubular, so that at least one of the bars of the mesh reinforcement can be inserted in the through-hole of the tubular anchoring bar. Alternatively, a bar section, separate from the mesh reinforcement of the façade panel, can be inserted in this tubular anchoring bar. The bar section can optionally cross with at least two bars of the mesh reinforcement, at the sides of the anchoring member, so as to strengthen the anchoring member encased in the façade panel.

According to another aspect, there is described a method for manufacturing a façade panel of the above-mentioned type, incorporating one or more of the above-mentioned anchoring members. The method described comprises the step of providing a formwork, in which a mesh reinforcement which is formed by bars which form a grid is inserted. At least one of these bars is inserted in the anchoring bar, which is constructed in tubular form, of at least one of the anchoring members. There can then be fluid concrete poured into the formwork which, when it dries/hardens, will form the façade panel. After the concrete has dried/hardened or when it is almost dry, it is possible to disengage and remove the front portion of the anchoring members from the respective base portions. Therefore, it is possible to remove the finished façade panel from the formwork. The front portions of the anchoring members can be recycled, or re-connected to respective new base portions in order to construct new anchoring members to be used in the construction of additional façade panels.

### BRIEF DESCRIPTION OF THE DRAWINGS

Additional features and advantages will be appreciated from the following detailed description of a preferred embodiment with reference to the appended drawings which are given purely by way of non-limiting example and in which:

FIG. 1 is a schematic perspective view of a construction site of stabilised earth;

FIG. 2 is a perspective view of an example of a façade panel incorporating aspects of the present invention;

FIG. 3 is a partially sectioned view of the façade panel of FIG. 2, wherein a portion of a mesh reinforcement can be seen;

FIG. 4 is a cross-sectional view of the façade panel according to the plane marked IV-IV of FIG. 2;

FIG. 5 is a perspective view of a first example of an anchoring member incorporating aspects of the present invention;

FIG. 6 is a perspective view of the anchoring member of FIG. 5 with two portions which are separated from each other;

FIG. 7 is a cross-sectional view of the anchoring member of FIG. 5, wherein the engagement between the two portions can be seen, and wherein the tubular anchoring element has been removed for the sake of clarity of illustration;

FIG. 8 is a cross-section, drawn to an enlarged scale, of one of the engaging members of the anchoring member of FIG. 7;

FIG. 9 is a partial view, as a cross-section similar to the one of FIG. 7, of a second example of an anchoring member, wherein a different engagement between the two portions can be seen;

FIG. 10 is a cross-section, drawn to an enlarged scale, of one of the engaging members of the anchoring member of FIG. 9;

FIG. 11 is a perspective view of a third example of the anchoring member;

FIG. 12 is a longitudinal section of the anchoring member of FIG. 11; and

FIG. 13 is a perspective view of a component of the anchoring member of FIG. 11.

### DETAILED DESCRIPTION

In the following embodiments, there are described characteristics which allow the invention to be carried out. The characteristics which are described can be combined with each other in various manners and are not necessarily limited to the precise embodiment, to which the drawings and relevant description refer. In other words, a person skilled in the art from the field who reads the following description will know how to obtain the useful information items and will know the way to carry out one more of the described characteristics by combining it with one or more of the other characteristics described without the particular formulation of the description, the paragraphs, the phrases or the drawings constituting a limit to the possibility of isolating one or more of the characteristics described and illustrated in order to combine them with one or more of any of the other characteristics described and illustrated. In greater detail, in the present description there must be understood to be expressly described any combination of any two characteristics expressly described, including the case in which the characteristics are individually extracted from the specific context in which they can be juxtaposed or combined with each other, different characteristics, taking into account competences and knowledge of a person skilled in the art who understands the possibility of functionally combining the characteristics without it being necessary to functionally apply other, different characteristics. Unless otherwise specified, each and any element, member, means, system, component, object described and illustrated in the present description must be understood to be individually described and autonomously able to be modified and separable from and/or combinable with each and any other element, member, means, system, component, object described and illustrated. The materials, forms and functions described and illustrated do not limit the present invention but are instead only specified in order to allow a person skilled in the art to understand and carry out the invention according to preferred but non-exclusive embodiments.

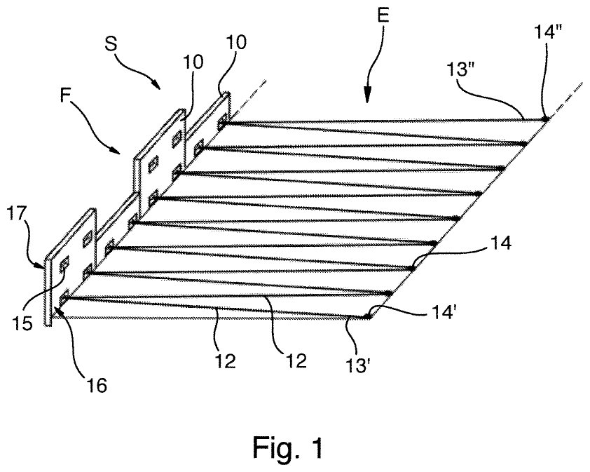

Now with reference to FIG. 1, a construction site S is schematically illustrated. On the construction site S, there is used an anchoring system in order to anchor façade panels 10 of a stabilised earth structure E. The façade panels 10 are preferably prefabricated from concrete. The façade panels 10 are positioned beside each other and/or one above the other in order to form the façade F of the stabilised earth structure E. The form, dimensions and mutual arrangement of the façade panels 10 may vary in accordance with the specific design and form part of the technology which is generally known to the persons skilled in the art.

The earth located behind the façade panels is reinforced by means of elongate reinforcement elements 12 which extend behind the façade F in a mass of earth. In the example of FIG. 1, which does not limit the possible configurations, the reinforcement elements 12 are formed by a single web-like element which has a first end 13′ which is fixed to a first ground anchor 14′. In some embodiments which are not illustrated, the reinforcement elements 12 are formed by single sections which are separated from each other. In other embodiments which are not illustrated, the reinforcement elements 12 are constructed by means of geostrips or sections of a geogrid which is cut into strips, preferably of approximately 9 cm or more.

The web-like element, which is illustrated in the non-limiting example of FIG. 1, runs in zigzag manner alternately between anchoring members 15 which are positioned on the rear wall of each façade panel 10 and intermediate ground anchors 14 as far as a second final ground anchor 14″, to which a second end of the web-like element is fixed. Naturally, the reinforcement elements 12 may comprise two or more web-like elements which are mutually independent. For example, it is possible to provide a number of web-like elements equal to the number of anchoring members 15 which are positioned on the rear walls of the façade panels 10, having a substantially V-like configuration, wherein the vertex of the V is wrapped around an anchoring member 15 and the ends of the two legs of the V are fixed to two respective ground anchors.

In greater detail, each anchoring member 15 is integrated in the rear face 16 of a panel 10 opposite a front face 17 which contributes to forming the actual façade F itself of the stabilised earth structure F, that is to say, the side which remains exposed to view when work is finished. For the sake of simplicity of illustration, FIG. 1 shows a configuration in which each panel 10 has a single anchoring member 15 with a predetermined height in an exemplary configuration of panels 10 which are staggered in alternation.

The number and the position of the anchoring members 15 on the rear face 16 of each panel can naturally be different from the one illustrated and can be adapted to any specific requirement in accordance with the design, the construction site, the dimension and form of the façade panels, the mutual position thereof (for example, staggered, aligned, superimposed, etc.) and the like.

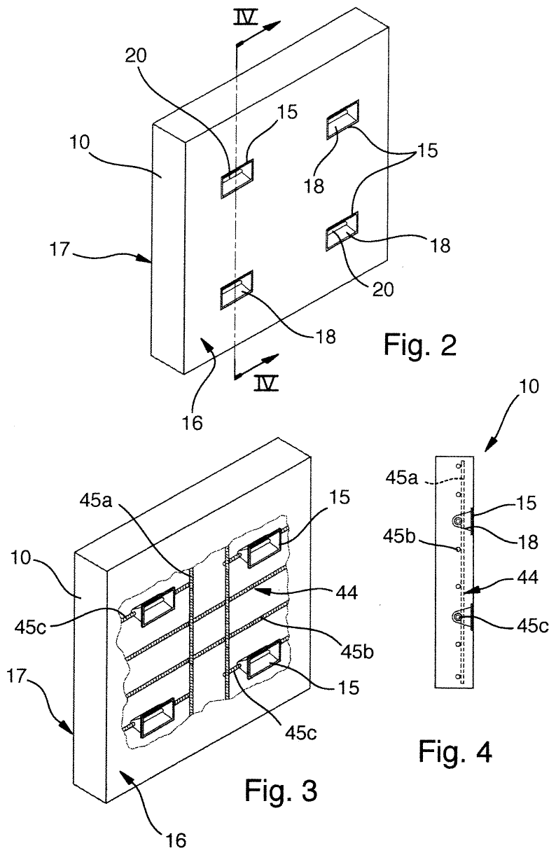

FIGS. 2 to 4 illustrate a façade panel 10 which is provided with anchoring members 15 which form respective cavities or recesses 18 in the rear face 16. The recesses 18 are passed through by an anchoring bar 20, around which during use of the façade panel 10 it is possible to wrap or fix a reinforcement element 12 of the web type, as illustrated in FIG. 1. In the example illustrated in FIGS. 2 to 4, the façade panel 10 is provided with four anchoring panels 15 which are arranged in a square, in pairs beside each other and superimposed. Naturally, this is only an illustrative non-limiting example because in practice the number and arrangement of the anchoring members 15 on the façade panel 10 may vary as desired, in accordance with the necessities of use or the planning and design characteristics of the stabilised earth structure.

As can be seen in FIGS. 3 and 4, the panel 10 is generally reinforced by a metal reinforcement 44 which is formed by vertical metal bars 45a and horizontal metal bars 45b which are distributed and incorporated in the panel 10 in a generally known manner. Shorter bar sections 45c of horizontal metal bars can be inserted in the anchoring bars 20 of the anchoring members 15. The bar sections 45c can be sufficiently long to cross two vertical bars 45a at the sides of each anchoring member 15. In more general terms, the bar sections 45c are sufficiently long bearing load, and not necessarily must cross the vertical bars of the metal reinforcement 44. Naturally, it is possible to insert in the anchoring bars 20, in place of the bar sections 25c, the longer horizontal bars 45b. However, the use of the bar sections 45c is preferable because it reduces the manufacturing cost and simplifies the positioning of the anchoring members 15 in the formwork for forming the panel 10.

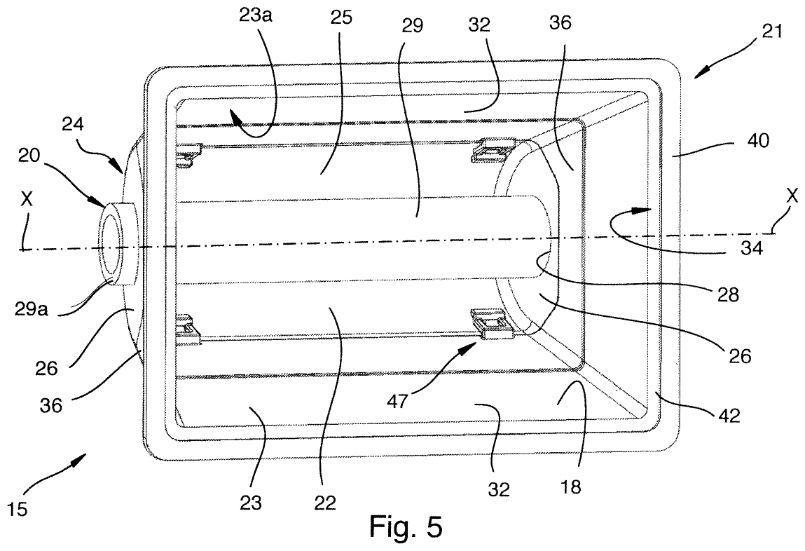

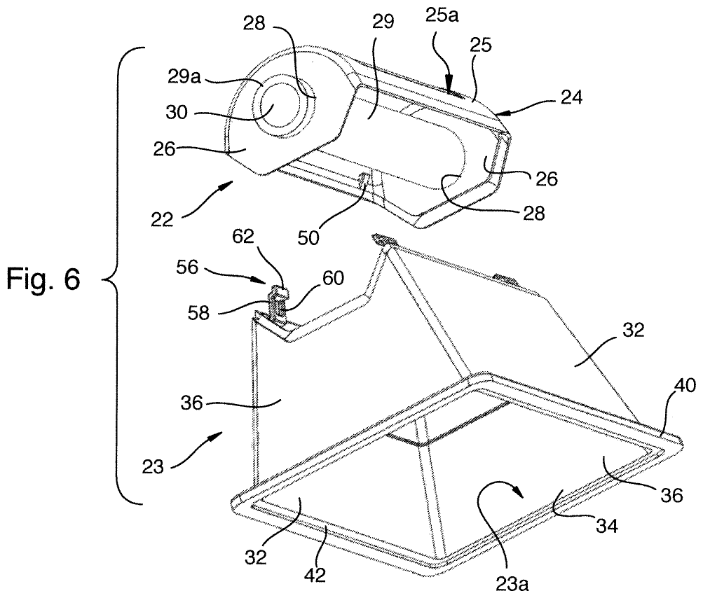

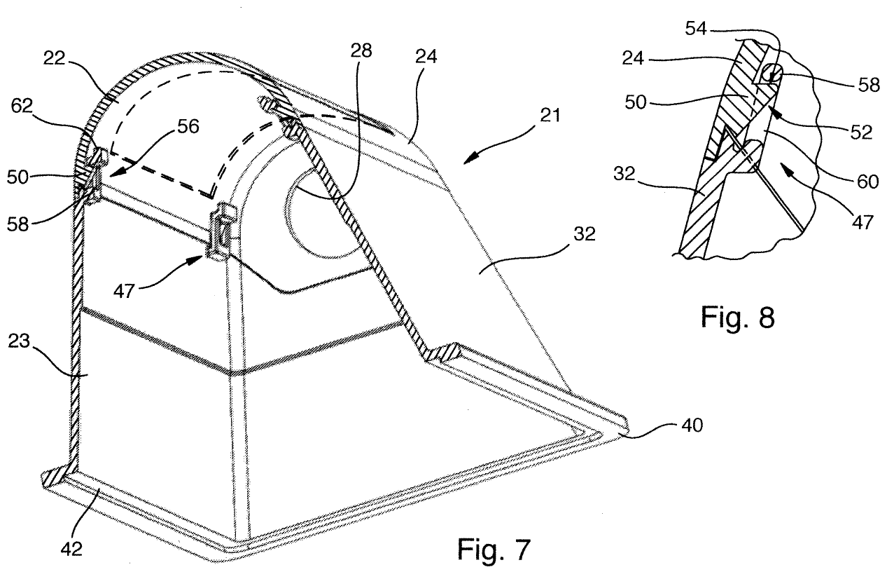

FIGS. 5 to 7 illustrate in greater detail the anchoring member 15 with a shell 21 which defines the recess 18. The shell 21 is subdivided into two portions: a base portion 22 and a front portion 23.

The base portion 22 comprises a shell 24 which is formed by a curved wall 25 which is preferably slightly less than semi-cylindrical and which is closed at the sides by two side walls 26, which are preferably planar. There are formed on the side walls 26 two respective holes 28 which are aligned along a common axis X-X. The anchoring bar 20 is produced by means of a tubular element 29 which is inserted in the holes 28. Preferably, the ends 29a of the tubular element 29 project outside the side walls 26 of the base portion 22 of the shell 21. The external diameter of the tubular element 29 is substantially equal to or slightly less than the diameter of the holes 28. There may be provided on the tubular element 29 and/or on the side walls 26 fluid-tight seals which prevent the concrete from being introduced into the shell 21 during the manufacture of the panel 10. The tubular element 29 has a through-hole 30 which is preferably substantially rectilinear, even if this does not exclude the fact that the hole may have a different extent, for example, an extent slightly bent in a V-shape. A metal bar 45b can be introduced into the through-hole 30, or preferably a metal bar section 45c, and/or concrete which, once solidified, contributes to making the shell 24 integral with the remainder of the panel 10 is introduced.

The front portion 23 of the shell 21 is substantially formed by walls which extend the structure of the base portion 22. In particular, the front portion 23 comprises two walls 32 which are parallel with the axis X-X and which converge from an opening 34 of the shell 21 towards the curved shell 24 so as to generally form therewith a V-shaped structure with a rounded vertex. The walls 32 can also be configured so as to form with the curved shell 24 a generally U-shaped or C-shaped structure and more generally a structure of the concave type. The front portion 23 is delimited at the sides by two side walls 36 which are preferably planar and which are positioned in continuation of the respective side walls 26 of the base portion 22.

The front portion 23 of the shell 21 defines the opening 34 which allows access to the internal recess 18 and which is delimited at the circumference thereof by a projecting frame 40. The projecting frame 40 may form a step 42 for peripheral support, on which there may be supported and/or embedded a cover (not illustrated) which serves to cover and protect the recess 18 when the concrete is poured in order to manufacture the panel 10.

The shell 21 can be formed by moulding, with a number of portions—which are less subject to forces—being reduced in terms of thickness in order to save material. For example, there may be provided a lightened zone 25a on the curved wall 25 of the base portion. Another lightened zone 23a can be formed in the wall of the front portion 23 of the shell 21.

In order to join the base portion 22 to the front portion 23 of the shell 21, there are provided engaging members 47 of the disengageable type. The engaging members 47 can be constructed in many manners, of which one example is illustrated in FIGS. 5 to 7 and in section, drawn to an enlarged scale in FIG. 8.

In greater detail, teeth 50 are constructed on the internal face of the shell 24 near the region thereof adjacent to the front portion 23. The teeth 50 are preferably constructed in one piece with the base portion 22 which is preferably completely constructed by moulding plastics material. As can better be seen in FIG. 8, each tooth 50 comprises a ramp-like portion 52 which is directed towards the front portion 23, which terminates in a step 54. A respective hook 56, which is constructed on the front portion of the shell 21 engages selectively with each tooth 50. The hooks 56 are preferably also constructed in one piece with the front portion 23 which is also preferably completely constructed by moulding plastics material. Each hook 56 comprises a flexible tongue 58 with an opening 60, in which the tooth 50 can be introduced, with snap-fitting engagement. At the end of the flexible tongue 58 there is provided a small projection 62, as a result of which it is possible to raise the flexible tongue 58 in order to release it from the tooth 50 in order to disengage the front portion 23 from the base portion 22 of the shell 21.

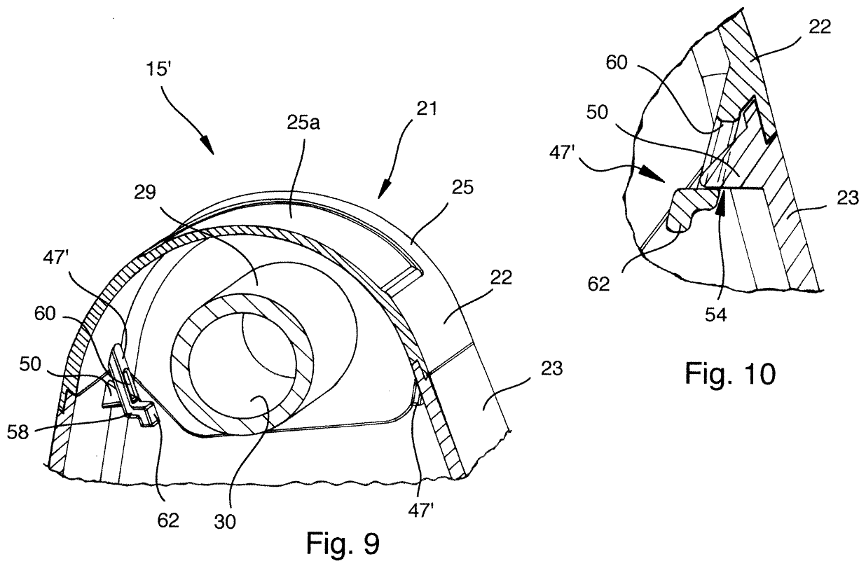

FIGS. 9 and 10 illustrate a variant of the anchoring member 15′ which differs from the anchoring member 15 described above only as a result of a variant of the engaging members 47′ between the base portion 22′ and the front portion 23′. In particular, there are inverted in the anchoring member 15′, with respect to the anchoring member 15, the position of the teeth 50′ and the hooks 56′ which are inverted with respect to what has been described above, all the other details of the engaging members 47′ which have been indicated with the same reference numerals as the ones used for the engaging members 47 and the detailed description of which applies in an identical, though specular, manner to the engaging members 47′ remaining the same.

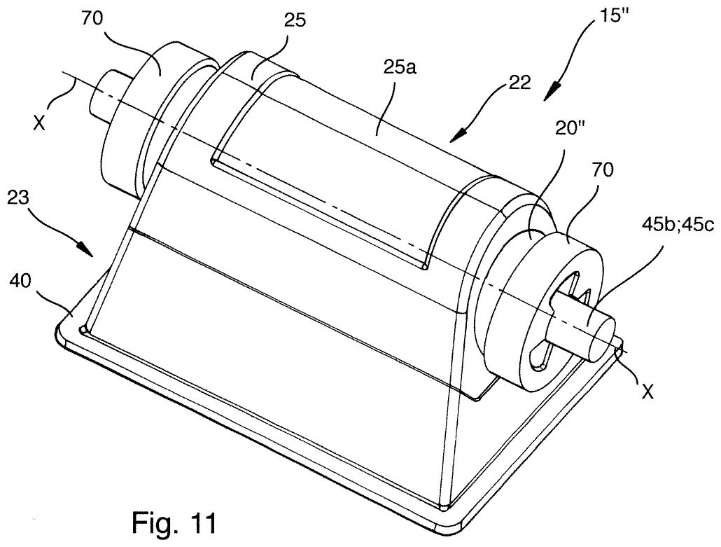

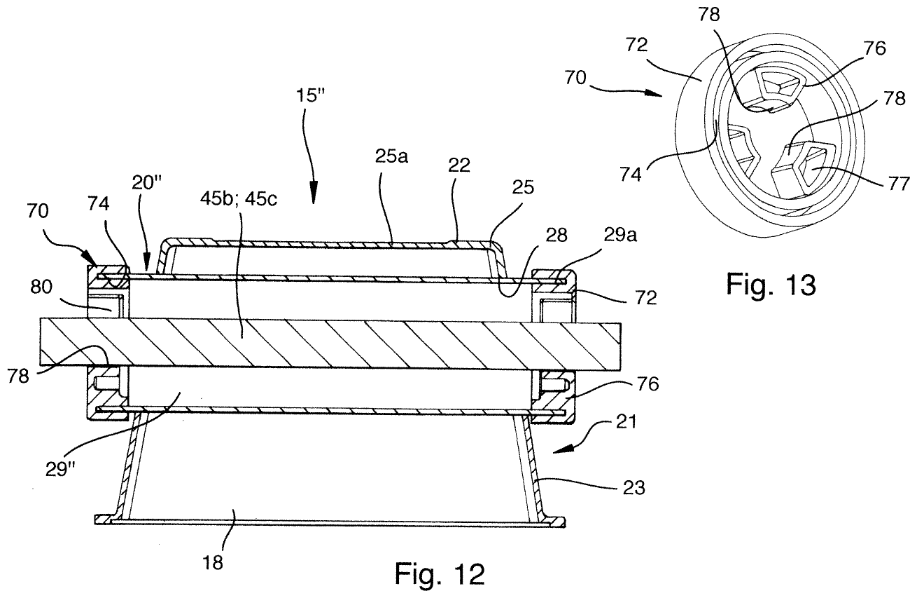

Now with reference to FIGS. 11 to 13, there is illustrated another example of an anchoring member 15″ which differs from the anchoring members described above substantially in that there is provided an anchoring bar 20″ with greater dimensions than those described above. In the Figures, identical reference £ numerals define details and characteristics which are identical to those already described above.

The anchoring bar 20″ is constructed by means of a tubular element 29″ which is inserted in the holes 28. The ends 29a of the tubular element 29″ project outside the side walls of the base portion 22 of the shell 21. There may be provided on the tubular element 29″ and/or on the side walls of the base portion 22 fluid-tight seals which prevent the concrete from being introduced into the shell 21 during the manufacture of the panel 10. The tubular element 29″ has a through-hole 30 which is substantially rectilinear and in which a metal bar 45b, preferably a metal bar section 45c, can be introduced together with concrete which, once solidified, contributes to making the anchoring member 15″ integral with the remainder of the panel 10. To this end, the internal diameter of the tubular element 29″ is greater than the diameter of the bar 45b or the bar section 45c which is inserted therein. The internal diameter of the tubular element 29″ can preferably vary from just slightly more than steel bar, up to approximately double the diameter of the bar 45b or the bar section 45c. However, nothing prevents the internal diameter of the tubular element 29″ to even greater, i.e. more than double the diameter of the bar 45b or the bar section 45c.

There are preferably mounted on the ends 29a of the tubular element 29″ centring members 70 which serve to keep centred and aligned the metal bar 45b or the bar section 45c in the tubular element 29″. The centring members 70 comprise an annular member 72, in which there is formed an annular channel 74 which is embedded or engaged in the end edge of the tubular element 29″. There project radially inwards from the annular member 72 a number of centring teeth 76, for example, three teeth in the example of FIG. 13, with lightening portions 77. The centring teeth 76 define respective portions of the annular wall 78 which keep centred the metal bar 45b or the metal bar section 45c. Openings 80 which leave free the communication between the internal cavity of the tubular element 29″ and the exterior are defined between one tooth 76 and the next in such a manner that, during the manufacture of the panel 10, the concrete can be introduced inside the tubular element 29″, surrounding the metal bar 45b or the metal bar section 45c so as to make the anchoring of the reinforcement element 12 much more robust during use around the anchoring bar 20″. Naturally, it is also possible to centre the metal bar 45b or the metal bar section 45c without using the centring members 70 by, for example, auxiliary external support members which are extraneous to and separate from the anchoring member and which keep the bar or the bar section raised in the correct position with respect to the internal cavity of the tubular element 29″.

In order to construct a façade panel 10, as known, there is provided a formwork inside which the metal web reinforcement 44 is placed. On one or more metal bars 45b of the metal web 44 or on metal bar sections 45c, there are mounted corresponding one or more anchoring members 15, 15′ or 15″ by inserting the metal bar 45b or metal bar section 45c in the tubular element 29 or 29″. As can be seen in the example of FIG. 4, there can also be mounted on the same metal rod 45b two or more anchoring members 15 which can be closed by respective covers (not illustrated) during the step of producing the panel 10.

Once the formwork has been provided with the mesh reinforcement 44 and the anchoring members 15, 15′ or 15″ in the desired positions, there is poured into the formwork the concrete which is necessary to form a façade panel 10. In particular, the concrete is poured up to a height which almost corresponds to the height at which the frame 40 of the anchoring members 15, 15′ or 15″ is positioned.

Once the drying of the concrete product has occurred, the front portions 23 of the anchoring members 15, 15′ or 15″ can be removed, by manually disengaging engaging members 47 or 47′, for example, by acting with a finger on the projections 62 of the flexible tongues 58 so as to release them from the respective teeth 50. In this manner, the front portions 23 can be re-used, by re-engaging them with other base portions 22 in order to bring about together new anchoring members 15, 15′ or 15″ to be used for manufacturing additional panels 10 made of concrete.

The particular shape of the shell 21 illustrated in the Figures is not intended to be understood in a limiting sense; for the same purpose and with the same advantages, there could be used a member which is, for example, parallelepipedal, pyramid-like, conical or frustoconical, cup-like, beaker-like, bowl-like, chalice-like, and similar variants, which are identically formed by at least two separable portions, as illustrated and described.

It is further possible for the anchoring bar 20 or 20′ to be obtained integrally in one piece with the shell 21 and particularly with the base portion 22 thereof, for example, by means of moulding or hot-injection of a plastics material.

Naturally, the principle of the invention remaining the same, the forms of embodiment and details of construction may be varied widely with respect to those described and illustrated without thereby departing from the scope of the present invention.

1. An anchoring member for incorporation into a facing panel for constructing stabilised earth structures, the anchoring member comprising:
a shell defining a recess with an opening; and
an anchoring bar extending transversely inside the recess and an elongate reinforcement element being passable around the anchoring bar during use;
wherein the shell is formed by at least:
a base portion carrying the anchoring bar; and
a front portion defining the opening and being releasably attached to the base portion.

2. The anchoring member as claimed in claim 1, further comprising engaging members, wherein the base portion is engaged with the front portion by the engaging members in a disengageable manner.

3. The anchoring member as claimed in claim 2, wherein the shell comprises teeth and the engaging members comprise one or more flexible tongues selectively engageable or disengageable from the respective teeth.

4. The anchoring member as claimed in claim 3, wherein the one or more flexible tongues are formed in one piece on the front portion and the teeth are formed in one piece on the base portion, or the one or more flexible tongues are formed in one piece on the base portion and the teeth are formed in one piece on the front portion.

5. The anchoring member as claimed in claim 4, wherein the one or more flexible tongues have projections raisable by hand by an operator.

6. The anchoring member as claimed in claim 1, the anchoring member being constructed entirely by moulding of a plastics material.

7. The anchoring member as claimed in claim 1, wherein the anchoring bar is tubular to allow during use insertion of a mesh reinforcement bar element or a bar section.

8. The anchoring member as claimed in claim 1, wherein the anchoring bar is constructed in one piece with the base portion of the shell.

9. The anchoring member as claimed in claim 1, wherein the anchoring bar is tubular and has an internal diameter greater than a diameter of a mesh reinforcement bar or a bar section inserted therein so as to also allow concrete to be introduced inside the anchoring bar.

10. The anchoring member as claimed in claim 9, comprising centering members mounted at ends of the anchoring bar to keep centered the mesh reinforcement bar or the bar section inside the anchoring bar.

11. A facing panel for a stabilised earth structure, the facing panel comprising:
a front exposed face;
a rear face, the rear face during use being positioned in contact with a mass of earth; and
one or more anchoring members, each of the one or more anchoring members comprising:
a shell defining at least one recess with an opening; and
an anchoring bar extending transversely inside the recess and an elongate reinforcement element being insertable into the opening and passable around the anchoring bar during use, the shell being formed by at least a base portion carrying the anchoring bar and a front portion defining the opening and being releasably attached to the base portion;
wherein the one or more anchoring members is incorporated inside the facing panel such that the opening is substantially aligned with and opens through the rear face of the facing panel.

12. The facing panel as claimed in claim 11, further comprising a mesh reinforcement formed by bars arranged to form a grid, the anchoring bar being tubular, at least one of the bars, or a separate bar section, being inserted in the anchoring bar.

13. The facing panel as claimed in claim 12, wherein a bar section is inserted in the anchoring bar and crosses with at least two bars of the mesh reinforcement, at sides of the one or more anchoring members.

14. A method for manufacturing a facing panel as claimed in claim 11, comprising the steps of:
providing a formwork;
inserting in the formwork a mesh reinforcement formed by bars arranged to form a grid, inserting at least one of the bars, or alternatively a bar section in the anchoring bar, constructed in tubular form, of at least one of the one or more anchoring members;
pouring fluid concrete into the formwork;
waiting for the concrete in the formwork to dry or harden;
disengaging and removing the front portion of the one or more anchoring members from the respective base portion; and
removing the finished facing panel from the formwork.
